(19) United States
(12) Patent Application Publication
(10) Pub. No.: US 2010/0319016 A1
(43) Pub. Date: Dec. 16, 2010

(54) METHOD AND APPARATUS FOR RECEIVING BROADCASTING SIGNAL

(76) Inventor: Hak Joo LEE, Seoul (KR)

Correspondence Address: KED & ASSOCIATES, LLP, P.O. Box 221200, Chantilly, VA, 20153-1200, US

(21) Appl. No.: 12/605,747

(22) Filed: Oct. 26, 2009

(30) Foreign Application Priority Data
Jun. 12, 2009 (KR) 10-2009-0052551

(51) Int. Cl. H04N 7/18; H04N 7/16

(52) U.S. Cl. 725/25; 725/83; 725/85

(57) ABSTRACT

A broadcast receiving method and apparatus are provided. The broadcast receiving method receives application data for a messaging service, through a data channel. The broadcast receiving method configures a message image with the received application data. The broadcasting receiving method compares personal identification information with identification information which is included in the application data, and when the personal identification information is the same as the identification information of the application data, it receives the application data for the messaging service.

### CROSS-REFERENCE TO RELATED APPLICATIONS

The present application claims priority under 35 U.S.C. 119 and 35 U.S.C. 365 to Korean Patent Applications No. 10-2009-0052551(filed on 12 Jun. 2009), which is hereby incorporated by reference in its entirety.

### BACKGROUND

The present disclosure relates to a broadcast receiving method and apparatus, and more particularly, to a broadcasting system, which provides a data broadcasting service in limited spaces such as hotels.

Generally, a broadcast receiving apparatus receives data stream including a broadcasting signal, and extracts video and audio data stream, corresponding to a channel that is desired by a user, using service information which is included in the received data stream to output the extracted stream to a display device.

Recently, by adding additional data to digital broadcasting and transmitting the digital broadcasting with the added data, data broadcasting is serviced which may provide various information to users. For example, the data broadcasting may provide program information on broadcasting channels, caption information, weather information, news information and/or shopping information to the users.

### SUMMARY

Embodiments provide a broadcast receiving method and apparatus, which can provide service for transferring messages to a specific receiver in limited spaces such as hotels.

In one embodiment, a broadcast receiving method includes: receiving application data for a messaging service, through a data channel; and configuring a message image with the received application data, wherein the receiving of application data includes: comparing personal identification information with identification information which is included in the application data; and receiving the application data for the messaging service, when the personal identification information is the same as the identification information of the application data.

In another embodiment, a broadcast receiving apparatus includes: a first tuner receiving a broadcasting signal of a broadcasting channel which is selected by a user; a second tuner extracting a signal of a data channel, and receiving application data for a messaging service; and an image processor combining an image of the broadcasting channel with a message image which is configured with the received application data, wherein the second tuner receives the application data for the messaging service, when personal identification information is the same as identification information which is included in the application data.

The broadcast receiving method may be realized with a computer-readable recording medium storing a program which is executed in a computer.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram illustrating the configuration of a broadcasting system according to an embodiment.

FIG. 2 is a block diagram illustrating the configuration of a head end apparatus which is managed in a hotel, according to an embodiment.

FIG. 3 is a block diagram illustrating the configuration of a broadcast receiving apparatus according to an embodiment.

FIG. 4 is a block diagram schematically illustrating the configuration of a broadcast receiving apparatus according to an embodiment.

FIG. 5 is a flowchart illustrating a broadcast receiving method according to an embodiment.

FIG. 6 is a flowchart illustrating a method in which a middleware transfers application data to an application, according to an embodiment.

FIG. 7 is a diagram illustrating a screen to which a messaging service in a hotel is provided, according to an embodiment.

### DETAILED DESCRIPTION OF THE EMBODIMENTS

Reference will now be made in detail to the embodiments of the present disclosure, examples of which are illustrated in the accompanying drawings.

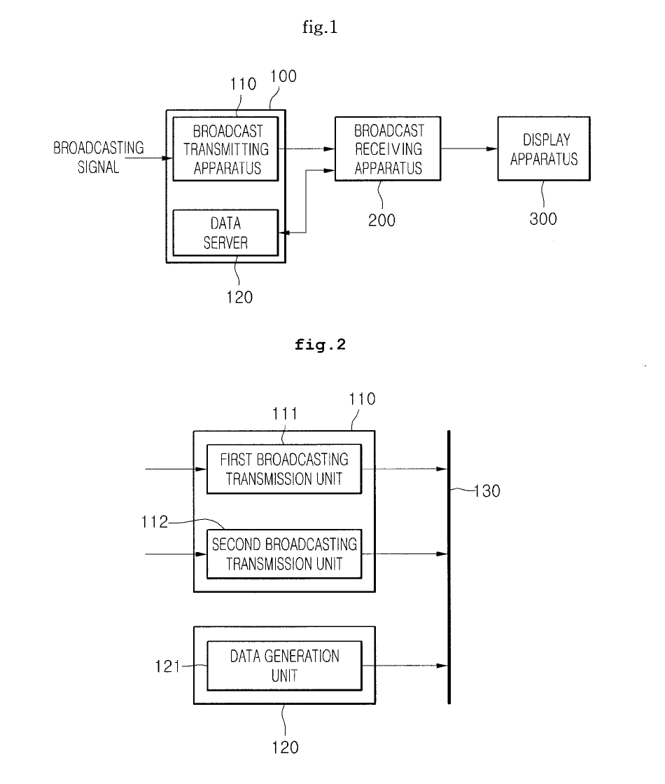

FIG. 1 is a block diagram illustrating the configuration of a broadcasting system according to an embodiment. The broadcasting system includes a head end apparatus 100, a broadcast receiving apparatus 200, and a display apparatus 300.

Referring to FIG. 1, the head end apparatus 100 receives a broadcasting signal from the outside to transmit the received signal to the broadcast receiving apparatus 200. The broadcast receiving apparatus 200 may extract and process the received broadcasting signal which corresponds to a channel that is selected by a user, and output the extracted and processed signal to the display apparatus 300.

Specifically, the head end apparatus 100 may include a broadcast transmitting apparatus 110 and a data server 120. The broadcast transmitting apparatus 110 may provide a broadcasting signal, which is received from the outside through satellite broadcasting or cable broadcasting, to the broadcast receiving apparatus 200. The data server 120 may provide application data for a data broadcasting service to the broadcast receiving apparatus 200.

For example, the broadcast transmitting apparatus 110 includes a plurality of broadcasting signal receivers. Accordingly, the broadcast transmitting apparatus 110 receives various contents from a plurality of broadcasting providers over wired/wireless communication networks using terrestrial antennas, satellite antennas and/or cables. The broadcast transmitting apparatus 110 allocates the received contents to a plurality of broadcasting channels and thereby transmits the contents to the broadcast receiving apparatus 200.

The broadcast receiving apparatus 200 may receive the broadcasting signal of a broadcasting channel that is selected by a user among a broadcasting signal which is transmitted from the broadcast transmitting apparatus 110. The broadcast receiving apparatus 200 may receive application data for data broadcasting that is transmitted from the data server 120.

The broadcast receiving apparatus 200 may respectively change the received broadcasting signal of the broadcasting channel and the application data for data broadcasting into a signal type and a data type that may be outputted in the display apparatus 300, and output the changed signal and data to the display apparatus 300.

The display apparatus 300 may display the image of the broadcasting channel by using the broadcasting signal that is inputted from the broadcast receiving apparatus 200, and provide a data broadcasting service according to a user's request.

The broadcast receiving apparatus 200 may be a set-top box (STB) that receives a broadcasting signal over wired/wireless networks, changes the received broadcasting signal into a signal type which may be outputted in the display apparatus 300 and outputs the changed signal to the display apparatus 300.

However, the broadcast receiving apparatus 200 is not limited to the STB. The broadcast receiving apparatus 200 may include all sorts of devices that may receive an external broadcasting signal and output the received signal to the display apparatus 300 which is connected in a wired/wireless manner.

The display apparatus 300 displays images corresponding to signals that are inputted from the broadcast receiving apparatus 200. For example, the display apparatus 300 may display the images by using various display devices such as Liquid Crystal Displays (LCD), plasma Display Panels (PDP), Electro Luminescent Displays (ELD) and Vacuum Fluorescent Displays (VFD).

The broadcast receiving apparatus 200 may be connected to the display apparatus 300 through High Definition Multimedia Interfaces (HDMI), Digital Visual Interface (DVI) or D-Sub cables. However, connection between the broadcast receiving apparatus 200 and the display apparatus 300 is not limited to the above-described connection type. The broadcast receiving apparatus 200 and the display apparatus 300 may be connected through various communication type cables. Moreover, connection between the broadcast receiving apparatus 200 and the display apparatus 300 is not limited to the cable type. The broadcast receiving apparatus 200 and the display apparatus 300 may be connected over a wireless network using local area wireless communication such as zigbee communication, bluetooth communication and Wlan communication.

According to an embodiment, the image of a broadcasting channel and the image of a data broadcasting service that are selected by a user may be simultaneously displayed on one screen in the display apparatus 300. For this, the broadcast receiving apparatus 200 may combine the broadcasting signal of a broadcasting channel that is received from the broadcasting transmission apparatus 110 with application data that are received from the data server 120, process the broadcasting signal and the application data so as to be displayed on one screen, and output the processed signal and data to the display apparatus 300.

Moreover, the application data that are received from the data server 120 may be a messaging service that allows a specific message to be displayed in the display apparatus 300.

For example, the data server 120 generates the application data including a message that is displayed in the display apparatus 300 and provides the generated data to the broadcast receiving apparatus 200. The broadcast receiving apparatus 200 may receive the application data for the messaging service to configure a message image, and output the message image to the display apparatus 300. The display apparatus 300 may display the message image that is inputted from the broadcast receiving apparatus 200.

In order for the broadcast receiving apparatus 200 receive the application data for the data broadcasting service from the data server 120 without changing a broadcasting channel that is currently being viewed, the application data may be transmitted to the broadcast receiving apparatus 200 through a dedicated data channel independent of the broadcasting channels.

That is, the broadcast transmitting apparatus 110 allocates an external broadcasting signal to a plurality of preset broadcasting channels and transmits the allocated signal to the broadcast receiving apparatus 200. The data server 120 transmits the application data to the broadcast receiving apparatus 200 through the separate dedicated data channel independent of the broadcasting channels. Therefore, the broadcast receiving apparatus 200 may simultaneously receive the application data for the data broadcasting and the broadcasting signal of a broadcasting channel that a user is currently viewing.

Accordingly, the user requests a data broadcasting service while viewing a selected broadcasting channel, and thus, it may use the data broadcasting service that is provided by the data server 120 of the head end apparatus 100 while continuously viewing the broadcasting channel without the change of a broadcasting channel.

In FIG. 1, the broadcast receiving apparatus 200 is included as a separate apparatus in the outside of the display apparatus 300. According to another embodiment, however, the broadcast receiving apparatus 200 may be included in the inside of the display apparatus 300 and be implemented as one set.

According to an embodiment, the broadcasting system in FIG. 1 may be used for providing a data broadcasting service in limited spaces such as hotels and hospitals, for example, a specific building.

Hereinafter, a general broadcasting service using external broadcasting signals and a hotel broadcasting system that provides a data broadcasting service in hotels will be exemplified as an embodiment.

That is, the broadcast receiving apparatus 200 and the display apparatus 300 may be disposed in the guest rooms of hotels. The head end apparatus 100 may receive broadcasting signals from the outside over satellites or cables, and transmit application data for data broadcasting of hotels and the received broadcasting signal to a plurality of broadcast receiving apparatuses 200 that are disposed in the guest rooms.

According to an embodiment, the data broadcasting service in hotels may be a messaging service in hotels that enables to transfer a desired message to a specific guest room by using the display apparatus 300 which is disposed in guest rooms.

For example, when telephone is received to the guest of a specific guest room in its absence, by displaying a relevant memo through the display apparatus 300 that is disposed in a corresponding guest room or displaying the hotel rate information checkout information of the corresponding guest room through the display apparatus 300, the messaging service in hotels may transfer a message including personal information and/or content to be transferred to the guest.

That is, the head end apparatus 100 in hotels generates and transmits a message to be transferred to a specific guest room, and the broadcast receiving apparatus 200 of the specific guest room receives the message to display the received message through the display apparatus 300 of the specific guest room, thereby transferring the message to the specific guest room.

For example, when intending to transfer a message “A” to an nth guest room, the data server 120 generates the application data including the message “A”, and transmits the generated application data over a radio frequency (RF) network of a hotel in an object carousel type.

Among all broadcast receiving apparatuses that are connected to the RF network, only the broadcast receiving apparatus 200 of the nth guest room receives the application data that are transmitted from the data server 120.

For this, the transmitted application data may include identification information for the reception target of the message, and the all broadcast receiving apparatuses that are connected to the RF network compare the identification information included in the transmitted application data with their own identification information. Only when the identification information of the transmitted application data is the same as the identification information of the respective broadcast receiving apparatuses, the respective broadcast receiving apparatuses may receive the application data.

Moreover, the data broadcasting service in hotels may include various services, for example, Pay Per View (PPV) services, room services, hotel-related information services, reservation services, checkout information services, entertainment services and game services, that may be provided in hotels, other than the banner advertisement service.

FIG. 2 is a block diagram illustrating the configuration of the head end apparatus 100 which is managed in hotels, according to an embodiment. The head end apparatus 100 of a hotel may include a plurality of broadcasting transmission units 111 and 112, and the data server 120 of a hotel which includes a data generation unit 121.

Referring to FIG. 2, the first and second broadcasting transmission units 111 and 112 may receive different kinds of contents from the outside, and more specifically, may receive broadcasting signals from different broadcasting providers or receive broadcasting signals over different communication networks.

For example, the first broadcasting transmission unit 111 may receive broadcasting signals, including content that is provided to the users of hotels without pay, from the outside and transmit the received signal to the broadcast receiving apparatus 200. The first broadcasting transmission unit 111 may include a converter and a transcoder for processing the received broadcasting signal.

Moreover, the first broadcast transmitting apparatus 110 may include an encryption unit and a modulator for processing broadcasting signals that are provided from a specific broadcasting provider (for example, a broadcasting provider for providing pay content).

The second broadcasting transmission unit 112 may receive external broadcasting signals including content that is provided to users with pay and transmit the received signal to the broadcast receiving apparatus 200. The second broadcasting transmission unit 112 may include a Video On Demand (VOD) processor for processing user's requests to the view of pay content, and a converter and a modulator for processing the received broadcasting signal.

The VOD processor may include a CPU, a memory, a VOD multiplexer and a content server, for processing the above-described VOD services.

As illustrated in FIG. 2, the data server 120 of a hotel may include the data generation unit 121 that generates application data for providing data broadcasting services in hotels according to a predetermined data broadcasting protocol.

For example, the data generation unit 121 may generate the application data for the data broadcasting services in hotels according to an Advanced Common Application Platform (ACAP) standard protocol.

Data broadcasting information based on the ACAP standard protocol may include Application Information Table (AIT) and Digital Storage Media-Command and Control (DSM-CC) data. The AIT and DSM-CC data may be transmitted in a Transport Stream (TS) type.

The AIT includes the presence of data broadcasting and update information. The DSM-CC data include substantial data for servicing data broadcasting, for example, control information including images and text fonts.

The data generation unit 121 may configure the DSM-CC data based on the ACAP standard protocol by using text data, Electronic Program Guide (EPG) or images that represent hotel-related information which is stored in the data server 120.

For providing the messaging service in hotels that is the data broadcasting service according to an embodiment, the data generation unit 121 may generate and output the application data that includes a message to be transmitted to a specific guest room, according to a preset data broadcasting protocol.

The application data for the messaging service, which are generated in the data generation unit 121, may include host identification (ID) being information on the broadcast receiving apparatus 200 of a specific guest room, message content to be transferred, message length and message valid time being information on message display time.

The broadcast receiving apparatus 200 compares its own host ID with a host ID included in the application data that are transmitted from the head end apparatus 100. When the host ID of the broadcast receiving apparatus 200 is the same as the host ID included in the application data, the broadcast receiving apparatus 200 recognizes a received message as a message that is transferred to it and receives the application data.

Referring to FIG. 2, an external broadcasting signal that is received from the broadcast transmitting apparatus and the application data (which are provided from the data server 120) for providing the data broadcasting service in hotels, for example, the messaging service in hotels, may be transmitted over one communication network 130 together.

That is, a broadcasting signal that is received from the first broadcasting transmission unit 111, a broadcasting signal that is received from the second broadcasting transmission unit 112 and the application data that are generated in the data generation unit 121 may be respectively allocated to different channels and be transmitted to the broadcast receiving apparatus 200 as one broadcasting signal over the communication network 130 which are installed in hotels.

According to an embodiment, the broadcasting signals that are received from the broadcast transmitting apparatus 110 and the application data (which are provided from the data server 120) for the messaging service may be transmitted to the broadcast receiving apparatus 200 together over the radio frequency (RF) cable of a hotel.

In this way, by transmitting the application data for providing the data broadcasting service in hotels over the RF cables which are installed for transmitting the broadcasting signal to the broadcast receiving apparatus 200 that is disposed in each of the guest rooms of hotels, the broadcasting system may provide the messaging service in hotels by using existing equipment without installing a separate network in hotels.

As described above, when a user requests the data broadcasting service in hotels, the broadcast receiving apparatus 200 should simultaneously receive the broadcasting signal of the broadcasting channel and the application data for the data broadcasting so that the image of a broadcasting channel that is currently being viewed on the screen of the display apparatus 300 and the image of the data broadcasting service can be displayed at the same time.

For this, the application data for the data broadcasting service in the hotel may be transmitted together with the broadcasting signal over the communication network 130 in the hotel, by using the dedicated data channel independent of the broadcasting channels through which the broadcasting signals are transmitted.

That is, the application data for the data broadcasting service in the hotel may be transmitted to the broadcast receiving apparatus 200 through the dedicated data channel independent of the broadcasting channels through which the broadcasting signals are transmitted. In more detail, the broadcasting channels do not even include a portion of the application data for the data broadcasting service in the hotel, and the dedicated data channel may include only the application data.

Accordingly, the data broadcasting service in the hotel, for example, the messaging service in a hotel may be provided together with the image of the broadcasting channel by using the application data that are received through the dedicated data channel when a user desires it, irrespective of a broadcasting channel which the user is currently viewing.

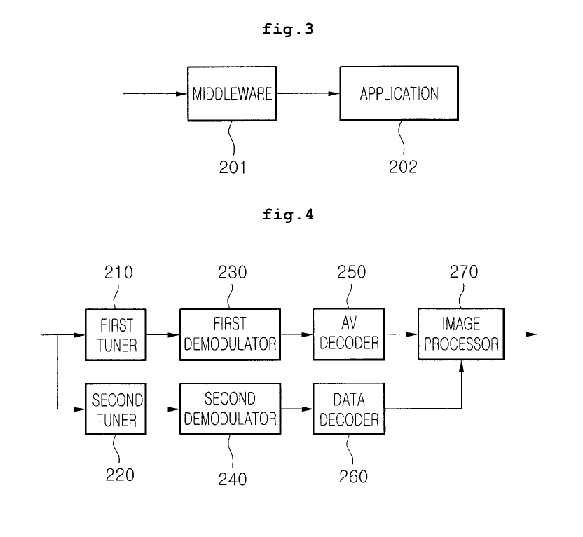

FIG. 3 is a block diagram illustrating the configuration of the broadcast receiving apparatus 200 according to an embodiment. The broadcast receiving apparatus 200 may include an application 202 and a middleware 201 for providing the messaging service in hotels.

Referring to FIG. 3, the broadcast receiving apparatus 200 checks whether a received message is a message to be transferred to it on the basis of the identification information of the application data that are transmitted from the head end apparatus 100. When the received message is a message to be transferred to the broadcast receiving apparatus 200, the broadcast receiving apparatus 200 receives the application data.

The middleware 201 analyzes the received application data, and transfers the application data to the application 202 for the messaging service.

The application 202 may configure a message image to be displayed in the display apparatus 300 by using the application data (which are transferred from the middleware 201) for the messaging service.

Hereinafter, a detailed operation for the messaging service in hotels on the middleware 201 and the application 202 in FIG. 3 will be described with reference to a broadcast receiving method according to an embodiment in FIG. 5.

Referring to FIG. 5, the broadcast receiving apparatus 200 compares its own host ID with the host ID of the application data that are transmitted from the head end apparatus 100 in operation 400. When the host IDs are identical, the broadcast receiving apparatus 200 receives the application data in operation 410.

The host ID is information for identifying the broadcast receiving apparatuses that are disposed in respective guest rooms, and the host ID of the application data is used to designate the broadcast receiving apparatus 200 receiving the message. The host ID may be included in the application data or may be the same as the file name of the application data.

According to an embodiment, when the host ID of the broadcast receiving apparatus 200 is the same as the file name of the application data that are transmitted from the head end apparatus 100, the broadcast receiving apparatus 200 receives the application data. For example, the host ID of the broadcast receiving apparatus 200 is “123456”, the broadcast receiving apparatus 200 receives the application data of a file “123456.msg”.

In operation 410, the broadcast receiving apparatus 200 receives the application data that are transmitted from the head end apparatus 100, through the dedicated data channel independent of the broadcasting channel.

Moreover, the broadcast receiving apparatus 200 includes a plurality of tuners. The application data for the messaging service may be received through a dedicated data tuner, i.e., a tuner which is included for receiving the application data for the messaging service, among the plurality of tuners.

According to an embodiment, the application data that are transmitted from the head end apparatus 100 and received to the broadcast receiving apparatus 200 may be configured as follows.

```
Host ID : 20 × 8bits
Length : 32 bits
for(j=0;j<N;j++){
    Application_identifier {
        Organization ID : 32bits
        Application ID : 16bits
    }
    for(k=0;k<N;k++){
        Message{
            Valid Time MMDDHHNNYYYY.SS : 15 × 8bits
            Data_Length : 32bits
            for(i=0;j<N;i++)
                Data : 8bits
        }
    }
}
```

In the message syntax, Host ID is identification information for designating the broadcast receiving apparatus 200 that receives a message included in the application data, Length represents the entire length of the application data other than the present Length field.

In the message syntax, Organization ID (OID) and application ID (AID) are information for identifying an application. More specifically, Organization ID (OID) is identification information for the manufacturer of the application, and application ID (AID) is identification information that is given to the application.

In the message syntax, Valid Time represents a message valid time, denotes that the message is deleted after the elapse of a corresponding time, and may be represented as a MMDDHHNNYYYY.SS type of character.

In the message syntax, Data_Length represents the length of message data next to the present Data_Length field, and Data is actual message data that represents the content of the message to be transferred.

The middleware 201 transfers the application data (which have the above-described configuration) for the messaging service to the application 202 in operation 420. The broadcast receiving apparatus 200 configures a message image by using the application 202 that receives the application data in operation 430.

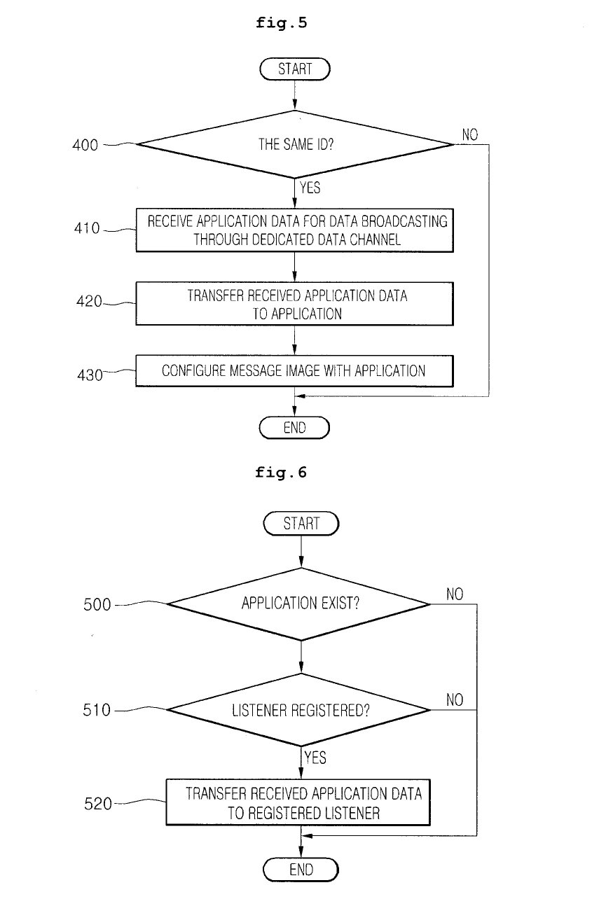

FIG. 6 is a flowchart illustrating a method in which the middleware 201 transfers the application data to the application 202 in operation 420, according to an embodiment.

Referring to FIG. 6, the middleware 201 checks whether an application for performing the messaging service exists in the broadcast receiving apparatus 200 in operation 500.

According to an embodiment, the middleware 201 analyzes the application data for the received messaging service to check whether the application 202 exists on the basis of application identification information that is included in the application data. For example, the middleware 201 may check whether the application 202 having the Organization ID (OID) and the application ID (AID).

In order for the middleware 201 to transfer the application data to the application 202, the following interface may be defined between the middleware 201 and the application 202.

```
package org.hcap.message;
public abstract class HMessageManager {
    public static HMessageManager getInstance ( ) {
        return null;
    }
    public abstract void addHMessageListener (HMessageListener
    listener)
    throws IllegalArgumentException;
    public abstract void removeHMessageListener(HMessageListener
    listener)
    throws IllegalArgumentException;
}
```

Herein, HMessageManager is an interface having a function in which the application 202 registers its own listener for receiving the application data to be transferred to it.

For example, the application 202 may obtain the object of HMessageManager through HMessageManager.getInstance( ) and register its own listener by using addHMessageListener.

According to an embodiment, the structure of the listener that is registered by the application 202 is as follows.

package org.hcap.message;
public interface HMessageListener {
public void notifyMessage (HMessageEvent event) ;
}

When the check result shows that the application 202 for performing the messaging service exists, the middleware 201 checks whether the application 202 registers the listener by use of the interface in operation 510.

When the application 202 has registered the listener, the middleware 201 transfers the received application data to the registered listener in operation 520.

According to an embodiment, the structure of an event that is transferred from the middleware 201 to the application 20202 in operation 520 is as follows.

```
package org.hcap.message;
import java.utill.Date;
public class HMessageEvent {
    private Date date;
    private String message;
    public HMessageEvent (Date date, String message) {
        this.date = date;
        this.message = message;
    }
    public Date getValidTime( ) {
        return date;
    }
    public String getMessage( ) {
        return message;
    }
}
```

The application 202 performs the messaging service by use of the application data that are transferred from the middleware 201, and therefore a message that is transferred from the head end apparatus 100 is displayed in the display apparatus 300.

FIG. 4 is a block diagram illustrating the entire configuration of the broadcast receiving apparatus 200 according to an embodiment. The broadcast receiving apparatus 200 may include a plurality tuners 210 and 220, a plurality of demodulators 230 and 240, a plurality of decoders 250 and 260, and an image processor 270.

Referring to FIG. 4, the first tuner 210 receives an broadcasting signal corresponding to a broadcasting channel that is selected by a user among a broadcasting signal which is transmitted from the head end apparatus 100, wherein the first tuner 210 may also receive the audio signal of the broadcasting channel together.

The second tuner 220 extracts a signal, which corresponds to the dedicated data channel, from a broadcasting signal that is transmitted from the head end apparatus 100, and receives the application data for the data broadcasting service in hotels, for example, the messaging service in hotels.

That is, the second tuner 220 may be a tuner that is stayed in the dedicated data channel and receives only the application data from the data server 120 of a hotel.

In this way, the second tuner 220 receives the signal of the dedicated data channel independent of the broadcasting channel that is received in the first tuner 210, and thus the broadcast receiving apparatus 200 may simultaneously receive the broadcasting signal of the broadcasting channel that is selected by the user and the application data for the data broadcasting service in hotels.

Moreover, even if a broadcasting channel that the user is currently viewing is not changed to a channel through which the application data are transmitted, the broadcast receiving apparatus 200 may receive both the application data for the data broadcasting service in hotels and the broadcasting signal of the broadcasting channel.

The first demodulator 230 may correct the error of the broadcasting signal of the broadcasting channel that is received from the first tuner 210 and change the broadcasting signal into the TS type. The AV decoder 250 may decode the received broadcasting signal and an audio signal to change the signals into a signal type that may be outputted in the display apparatus 300.

The second demodulator 240 performs the above-described demodulation operation on the application data that are received from the second tuner 220. The data decoder 260 may decode the application data to configure an image for the data broadcasting service in hotels.

According to an embodiment, the data decoder 260 decodes the application data to configure a message image for the messaging service in hotels.

For example, the data decoder 260 may decode the application data according to the ACAP standard protocol to configure a message image.

More specifically, the data decoder 260 may parse the AIT session of the application data to read an identifier corresponding to the DSM-CC data, and filter the DSM-CC data of a location (which corresponds to the identifier), thereby extracting substantial information for providing the message image.

The image processor 270 may combine the image data of a broadcasting channel that is outputted from the AV decoder 250 with the image data of a data broadcasting service that are outputted from the data decoder 260 so that the image of a broadcasting channel that is selected by the user and the image of the data broadcasting service can be simultaneously displayed on one screen in the display apparatus 300.

Through the above-described method, the broadcast receiving apparatus 200 configures a message image with the application data that are received from the head end apparatus 100, and combines the message image with the image of the broadcasting channel to output the combined image to the display apparatus 300. Therefore, both the image of the broadcasting channel and the message image to be transferred from the head end apparatus 100 are displayed on the screen of the display apparatus 300.

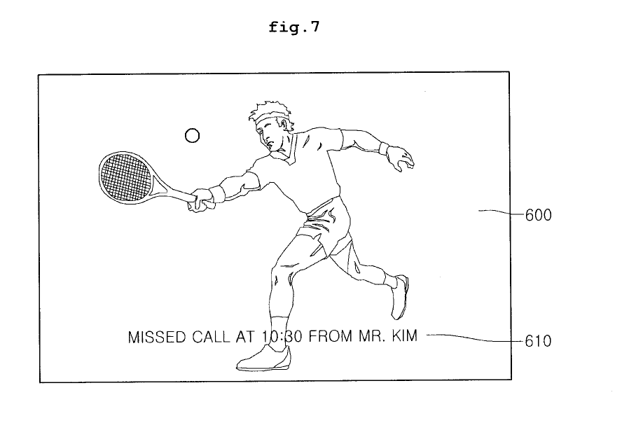

FIG. 7 is a diagram illustrating a screen to which the messaging service in hotels is provided, according to an embodiment. FIG. 7 illustrates a messaging service screen that is provided through the above-described method, according to an embodiment.

As described above, since the application data for the messaging service and the broadcasting signal of the broadcasting channel are simultaneously received through the dedicated data channel, hotels may display the message image 610 including desired content at a desired time in order for the message image 610 to overlap on the image 500 of the broadcasting channel, irrespective of a broadcasting channel that the user is viewing.

In the above description, although the broadcast receiving method and apparatus and the broadcasting system according to embodiments have exemplified a case of providing the data broadcasting service in hotels, it is not limited thereto. The broadcast receiving method and apparatus and the broadcasting system may be used for various data broadcasting services that are provided in limited spaces such as hotels and hospitals, or a data broadcasting service based on a Global Executable MHP (GEM)-based protocol.

The broadcast receiving method according to embodiments can also be embodied as computer readable codes on a computer-readable storage medium. The computer-readable storage medium is any data storage device that can store data which can be thereafter read by a computer system. Examples of the computer-readable storage medium include ROMs, RAMs, CD-ROMs, DVDs, magnetic tapes, floppy disks, registers, buffers, optical data storage devices, and carrier waves (such as data transmission through the Internet).

The computer-readable storage medium can also be distributed over network coupled computer systems so that the computer readable codes are stored and executed in a distributed fashion. Also, functional programs, codes, and code segments for accomplishing embodiments can be easily construed by programmers skilled in the art to which the present invention pertains.

According to embodiments, by receiving the application data for the data broadcasting through the dedicated data channel independent of the broadcasting channels, the broadcasting system can provide the data broadcasting service to users without the change of the broadcasting channel that the users are currently viewing. Moreover, the broadcasting system separately includes the tuner for receiving the application data of the dedicated data channel, and thus can easily realize the data broadcasting service that is provided in limited spaces such as hotels, independently of the general broadcasting service.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for receiving broadcasting signal, comprising:
receiving application data for a messaging service through a data channel; and
configuring a message image with the received application data,
wherein the receiving of application data comprises:
comparing personal identification information with identification information which is comprised in the application data; and
receiving the application data, when the personal identification information is the same as the identification information of the application data.

2. The method according to claim 1, comprising:
receiving an broadcasting signal of a broadcasting channel which is selected by a user; and
combining an image of the broadcasting channel with the configured message image.

3. The method according to claim 2, wherein the broadcasting signal of the broadcasting channel and the application data of the data channel are simultaneously received.

4. The method according to claim 2, wherein the broadcasting signal of the broadcasting channel and the application data of the data channel are received through different tuners.

5. The method according to claim 2, wherein the broadcasting signal of the broadcasting channel and the application data of the data channel are received through a radio frequency (RF) cable which is installed in a hotel.

6. The method according to claim 1, wherein the application data are received from a data server of a hotel.

7. The method according to claim 1, wherein the application data are transmitted through the data channel in an object carousel type.

8. The method according to claim 1, wherein in the receiving of application data,
the application data are received, when a file name of the application data is the same as personal host identification (ID).

9. The method according to claim 1, wherein the application data for the messaging service in a hotel comprise host identification (ID) and message content.

10. The method according to claim 9, wherein the application data comprise information on at least one of message length and message valid time.

11. The method according to claim 1, wherein the configuring of a message image comprises:
checking a message application for performing the messaging service in a hotel; and
transferring the received application data to the message application.

12. The method according to claim 11, wherein the checking of a message application comprises:
checking whether an application exists which corresponds to application identification information which is comprised in the application data; and
checking whether the application registers a listener, when the application exists.

13. An apparatus for receiving broadcasting signal, comprising:
a first tuner receiving an broadcasting signal of a broadcasting channel which is selected by a user;
a second tuner extracting a signal of a data channel, and receiving application data for a messaging service; and
an image processor combining an image of the broadcasting channel with a message image which is configured with the received application data,
wherein the second tuner receives the application data for the messaging service, when personal identification information is the same as identification information which is comprised in the application data.

14. The apparatus according to claim 13, wherein while the first tuner is receiving the broadcasting signal of the broadcasting channel, the second tuner receives the application data of the data channel.

15. The apparatus according to claim 13, wherein the image processor allows an image of the broadcasting channel and the configured message image to be displayed on one screen.

16. The apparatus according to claim 13, wherein the second tuner receives the application data, when a file name of the application data is the same as personal host identification (ID).

17. The apparatus according to claim 13, wherein a middleware checks an application for performing the messaging service in a hotel, and transfers the application data to the application.

18. The apparatus according to claim 17, wherein the application configures the message image with the transferred application data.

19. The apparatus according to claim 17, wherein the middleware checks whether an application exists which corresponds to application identification information which is comprised in the application data, and whether the application registers a listener.

20. A computer-readable recording medium storing a program for executing a broadcast receiving method according to claim 1.
